(19) United States
(12) Patent Application Publication
(10) Pub. No.: US 2016/0180497 A1
(43) Pub. Date: Jun. 23, 2016

(54) METHOD FOR GEOMETRIC IMAGE TRANSFORMATION BASED ON A MUG GEOMETRY

(71) Applicant: Vincent Hallé, Québec (CA)

(72) Inventor: Vincent Hallé, Québec (CA)

(21) Appl. No.: 14/976,668

(22) Filed: Dec. 21, 2015

Related U.S. Application Data
(60) Provisional application No. 62/094,537, filed on Dec. 19, 2014.

(51) Int. Cl. G06T 3/00

(52) U.S. Cl. CPC G06T 3/0012

(57) ABSTRACT

A non-transient computer readable medium containing program instructions for causing a computer to perform a method of redrawing an image, the image being usable to decorate a mug having given parameters. The program instructions, according to one embodiment of the method, calculate a first aspect ratio of the mug. The user can then select a selection from the initial image based on the first aspect ratio. Once the selection has been performed, the number of pixels of the selection is adjusted to achieve a high resolution in the transformed image. The program creates a modified image zone. The pixels of the modified image zone are given specific coordinates. A calculation is made to select a corresponding pixel from the selection and places the corresponding pixel in the modified image zone to create the modified image.

### FIELD OF THE INVENTION

The present invention relates to mug decorations. More particularly, the present invention relates to a method for geometric image transformation to personalize mugs, cups and the like.

### BACKGROUND OF THE INVENTION

Known in the art are mugs 30 having predefined images 32 as the one illustrated in FIG. 1. These images may include themes, such as images from movie themes or images of people, such as actors and singers. Other images used may simply reflect a natural caption and/or hobbies such as cars, planes and the like. In recent years, personalized images have become increasingly popular due to the flexibility and accessibility of digital cameras. However, personalizing mugs by printing and pasting images on the mugs can be difficult, complicated and may require special skills such as an artistic manipulation of the images. In addition, the manipulated image might also be deformed during the manipulation in cases where the shape and size of the mug differs from the shape and size of the initial image.

With the rise of the digital photos and digital imaging, there is a need for an efficient, simple and economical way to personalize mugs, cups and the like using personal digital images.

### SUMMARY OF THE INVENTION

The object of the present invention is to provide a method of redrawing an image which, by virtue of its steps, satisfies some of the above-mentioned needs. According to an object of the present invention, there is provided a non-transient computer readable medium containing program instructions for causing a computer to perform a method of redrawing an image, the image being usable to decorate a mug having given parameters, the method comprising the steps of:
uploading an initial image having a number of pixels;
calculating a first aspect ratio according to the given parameters;
selecting a selection from the initial image, wherein the selection has a second aspect ratio, such that the second aspect ratio corresponds to match the first aspect ratio;
adjusting the number of pixels of the selection;
creating a modified image zone;
calculating, for each pixel of the modified image zone, a corresponding angle and radius based on the parameters of the mug;
creating a modified image based on the calculated angle and radius of each pixel of the modified image zone, wherein the calculated angle and radius is mapped to a corresponding pixel from the selection; and
drawing a cutting line around the modified image to guide a user in cutting the modified image.

The objects, advantages and features of the present invention will become more apparent upon reading of the following non-restrictive description, given for the purpose of exemplification only, with reference to the accompanying drawings.

### BRIEF DESCRIPTION OF THE DRAWINGS

FIG. 1 is a perspective view of a personalized mug according to prior art.

FIGS. 2A to FIG. 6 schematically illustrate the general steps of a method for geometric image transformation based on the geometry of a mug according to an aspect of the present invention.

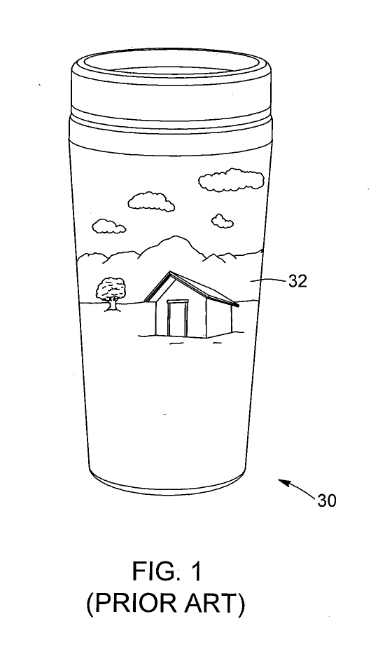

### DESCRIPTION OF PREFERRED EMBODIMENTS OF THE INVENTION

In the following description, similar features in the drawings have been given similar reference numerals.

In the context of the present invention, the order of the steps of the method described herein should not be taken as to limit the scope of the invention, as the sequence of the steps may vary in a number of ways, without affecting the scope or working of the invention, as can also be understood by a person skilled in the art.

Furthermore, the expressions “mug”, “cup”, “glass”, “pencil holder” and any other equivalent expression and/or compound words thereof known in the art will be used interchangeably. Furthermore, the same applies for any other mutually equivalent expressions, such as “cylindrical”, “tubular”, “conical” and “frusto-conical”, for example, as also apparent to a person skilled in the art.

Broadly described, the method of redrawing an image according to the present invention, as exemplified in the accompanying drawings, is a non-transient computer readable medium containing program instructions for causing a computer to perform a method of redrawing an image, the image being usable to decorate a frusto-conical object such as a mug, cup, pencil holder, etc., having given geometrical parameters.

For the sake of clarity, certain reference numerals have been omitted from the figures when they have already been identified in a preceding figure.

In accordance with one aspect, there is provided a method for geometric image transformation based on mug geometry.

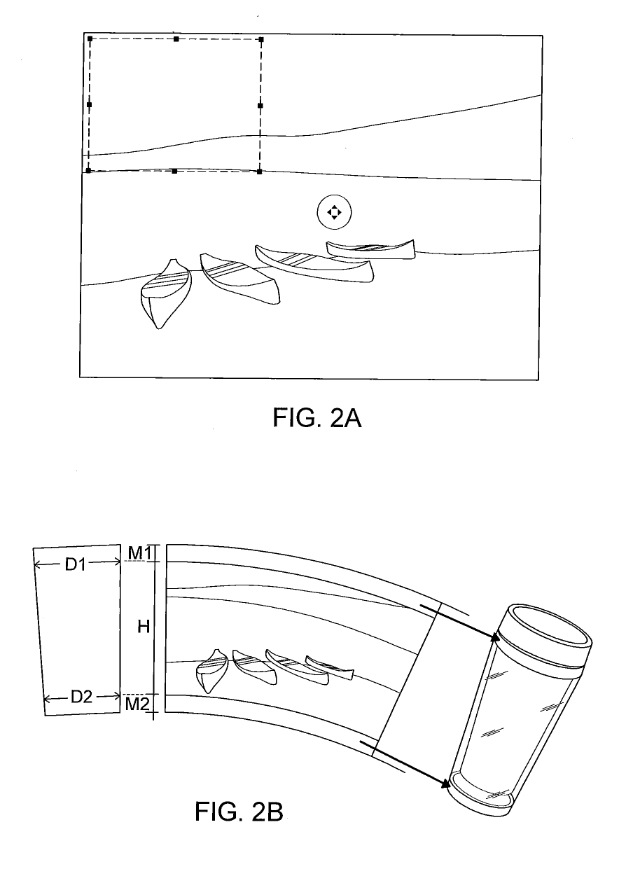

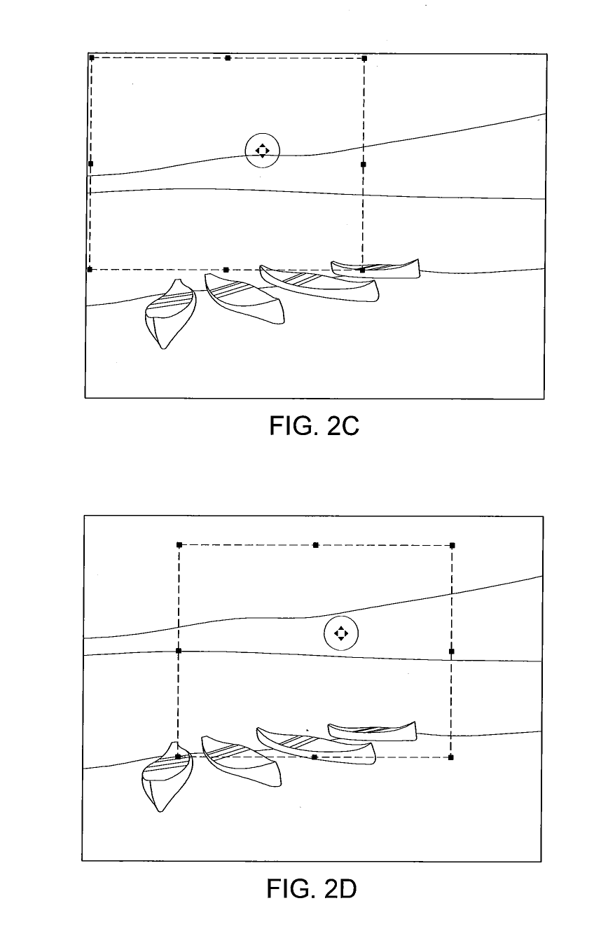

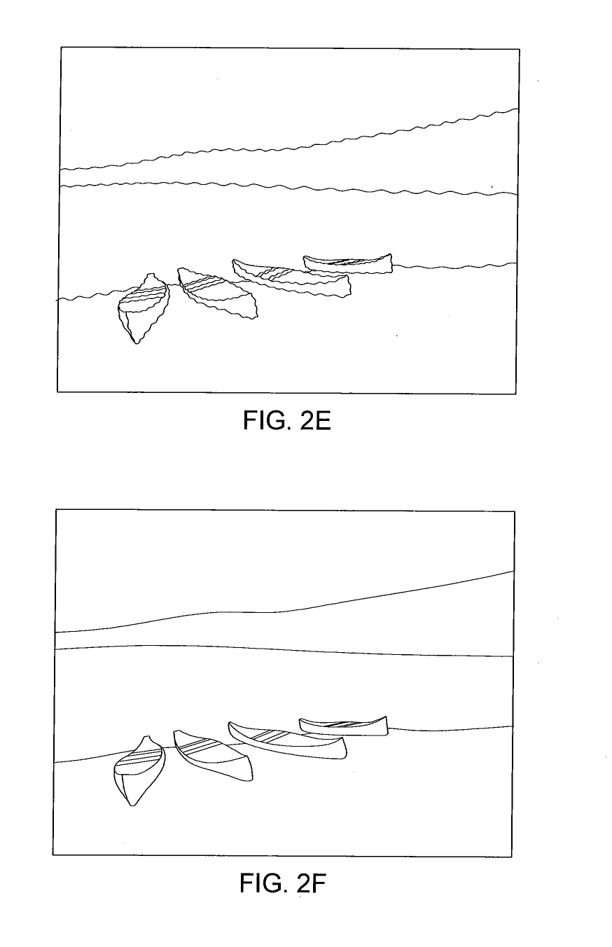

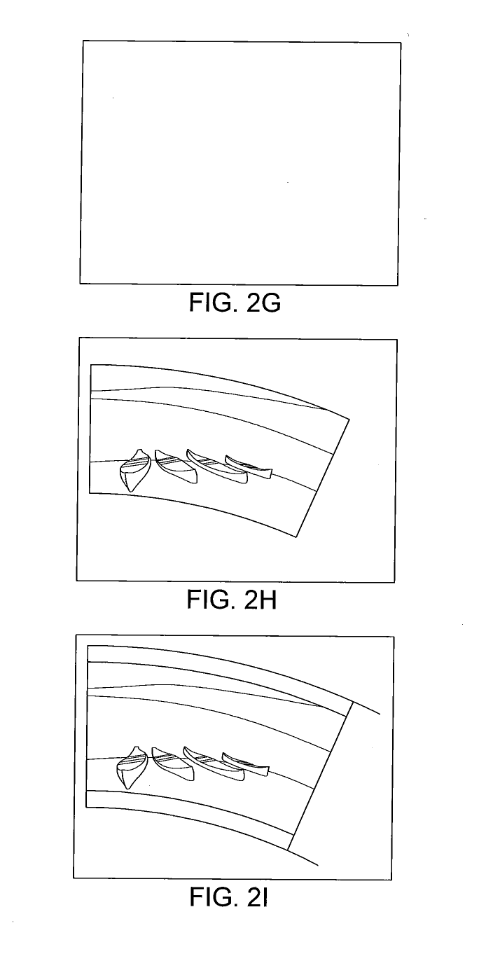

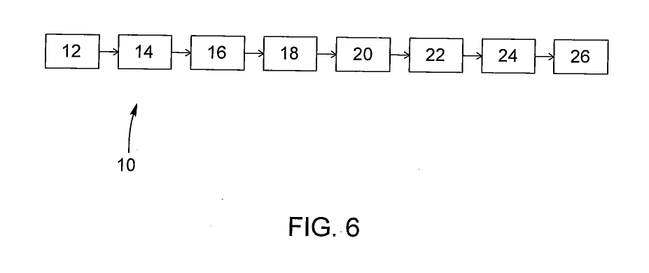

With reference to FIGS. 2 and 6, there is shown the steps of a non-transient computer readable medium containing program instructions for causing a computer to perform a method 10 of redrawing an image to decorate a mug having given parameters according to one embodiment. The given parameters of the mug may comprise an upper diameter, a lower diameter, a height, an upper margin and a lower margin, as illustrated in FIG. 2B.

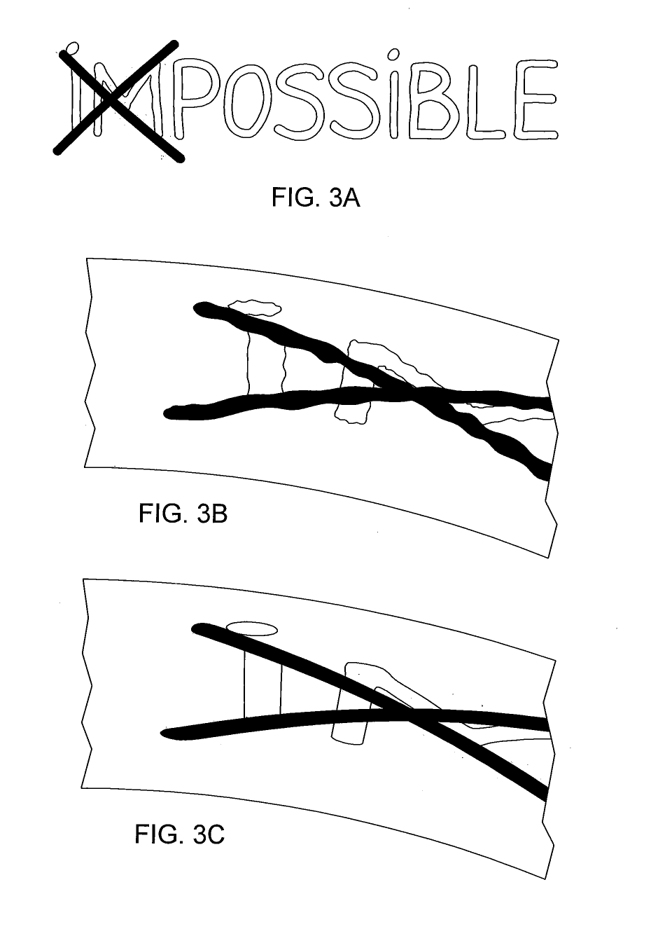

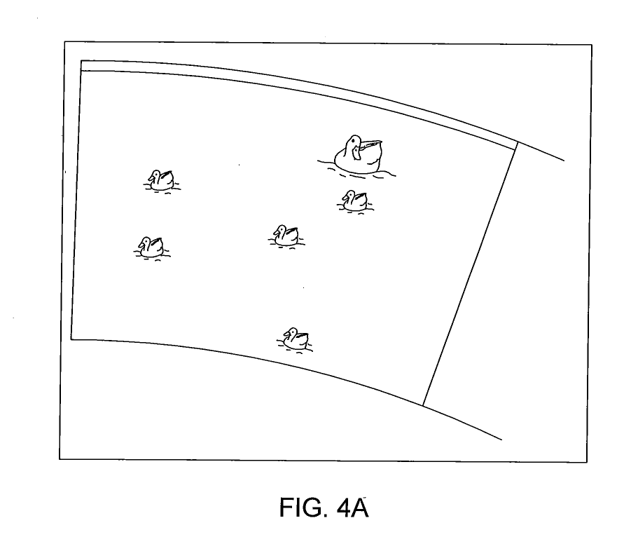

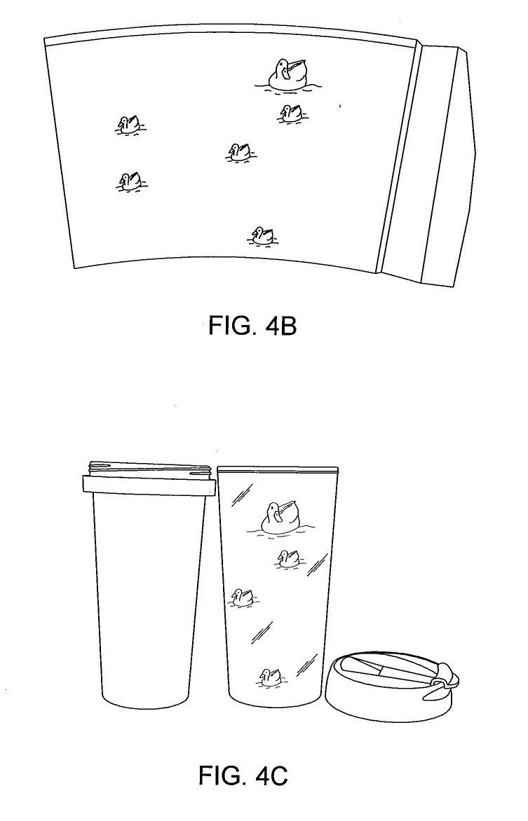

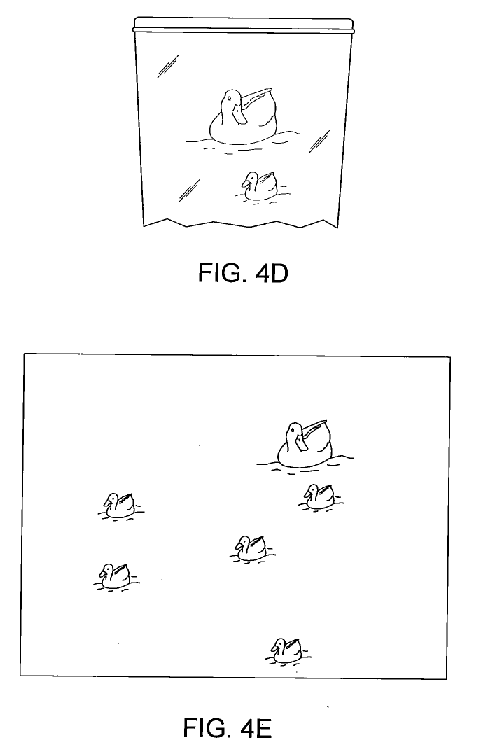

The method 10 includes the step uploading an initial image 12 having a given number of pixels. A higher number of pixels in a given image gives a higher resolution of the image, as better illustrated in FIG. 3. The initial image may be uploaded from a digital camera, a memory disk, or any other medium. The uploaded image might have any dimension. However, depending on the dimensions of the mug, only a specific range of aspect ratios may be used from the initial image to achieve the best results.

The first aspect ratio corresponds to the aspect ratio of the mug. The first aspect, ratio can be calculated 14 according to the following equation:

((D1+D2)/2*π)/Hm

wherein
D1: upper diameter;
D2: lower diameter;
Hm: height of modified image;
π: Pi.

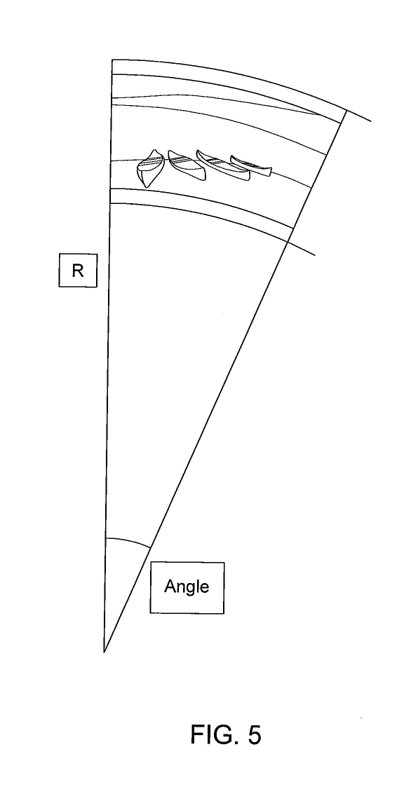

The first aspect ratio enables the selection of a proper size from an initial image 16 in order to avoid deforming a modified image that will be used to decorate the mug. In other words, the aspect ratio of the selection should match the aspect ratio of the mug. The number of pixels of the selection must be adjusted 18 to achieve a high resolution in the transformed image. A modified image zone may be created 20 as illustrated in FIG. 2G. For each pixel of the modified image zone, a pixel coordinate is defined in terms of an angle and radius 22 as illustrated in FIG. 5. The calculation is based on the parameters of the mug, as better illustrated in FIG. 2B. This calculation may also be done using different coordinate systems, such as a Cartesian coordinate system.

The modified image can be created 24 by selecting pixels from the selection and placing the pixels in a corresponding coordinate in the modified image zone.

In order to guide a user in cutting the modified image, a cutting line can be drawn 26 around the modified image as illustrated in FIG. 2I. This cutting line may also be used to guide the user in bending and mounting the image on to the mug in order to personalize the mug.

In use, a user enters the given parameters of the mug and uploads an initial image 12. The program instructions, according to one embodiment of the method, calculate a first aspect ratio of the mug 14. The user can then select a selection from the initial image based on the first aspect ratio 16. Once the selection has been performed, the number of pixels of the selection is adjusted 18. The program creates a modified image zone 20. The pixels of the modified image zone are given specific coordinates 22. A calculation is made to select a corresponding pixel from the selection and places the corresponding pixel in the modified image zone to create the modified image 24. In some embodiments, the method includes the step of drawing a cutting line around the modified image 26 to guide a user in cutting the modified image after the modified image has been printed.

### Exemplary Algorithm

It will be readily understood by one skilled in the art that the present invention may be embodied by different devices, hardware, elements, combinations of elements or the like in different arrangements than shown in the appended drawings and described herein. Additional hardware may also be provided depending on the need of a particular application as is well known in the art. Of course, numerous modifications could be made to the embodiments described above without departing from the scope of the present invention as defined in the appended claims.

1. A non-transient computer readable medium containing program instructions for causing a computer to perform a method of redrawing an image, the image being usable to decorate a mug having given parameters, the method comprising the steps of:
a. uploading an initial image having a number of pixels;
b. calculating a first aspect ratio according to the given parameters;
c. selecting a selection from the initial image, wherein the selection has a second aspect ratio, such that the second aspect ratio corresponds to match the first aspect ratio;
d. adjusting the number of pixels of the selection;
e. creating a modified image zone;
f. calculating, for each pixel of the modified image zone, a corresponding angle and radius based on the parameters of the mug;
g. creating a modified image based on the calculated angle and radius of each pixel of the modified image zone, wherein the calculated angle and radius is mapped to a corresponding pixel from the selection; and
h. drawing a cutting line around the modified image to guide a user in cutting the modified image.

2. The non-transient computer readable medium as claimed in claim 1, further comprising between steps c and d a step of adjusting the number of pixels of the selection.

3. The non-transient computer readable medium as claimed in claim 1, wherein a shape of the mug is selected from the group comprising cylindrical, frusto-conical and conical shapes.

4. The non-transient computer readable medium as claimed in claim 2, wherein a shape of the mug is selected from the group comprising cylindrical, frusto-conical and conical shapes.

5. The non-transient computer readable medium as claimed in claim 1, wherein the given parameters of the mug comprise an upper diameter, a lower diameter, a height, an upper margin and a lower margin.

6. The non-transient computer readable medium as claimed in claim 2, wherein the given parameters of the mug comprise an upper diameter, a lower diameter, a height, an upper margin and a lower margin.

7. The non-transient computer readable medium as claimed in claim 3, wherein the given parameters of the mug comprise an upper diameter, a lower diameter, a height, an upper margin and a lower margin.

8. The non-transient computer readable medium as claimed in claim 4, wherein the given parameters of the mug comprise an upper diameter, a lower diameter, a height, an upper margin and a lower margin.

9. The non-transient computer readable medium as claimed in claim 5, wherein the calculating step utilizes the upper margin and lower margin in order to create the modified image shaped to fit in a visible portion of the mug.

10. The non-transient computer readable medium as claimed in claim 6, wherein the calculating step utilizes the upper margin and lower margin in order to create the modified image shaped to fit in a visible portion of the mug.

11. The non-transient computer readable medium as claimed in claim 7, wherein the calculating step utilizes the upper margin and lower margin in order to create the modified image shaped to fit in a visible portion of the mug.

12. The non-transient computer readable medium as claimed in claim 8, wherein the calculating step utilizes the upper margin and lower margin in order to create the modified image shaped to fit in a visible portion of the mug.

13. The non-transient computer readable medium as claimed in claim 1, further comprising the step of adjusting the size of the modified image to match the size of the mug.

14. The non-transient computer readable medium as claimed in claim 2, further comprising the step of adjusting the size of the modified image to match the size of the mug.

15. The non-transient computer readable medium as claimed in claim 3, further comprising the step of adjusting the size of the modified image to match the size of the mug.

16. The non-transient computer readable medium as claimed in claim 3, further comprising the step of adjusting the size of the modified image to match the size of the mug.

17. The non-transient computer readable medium as claimed in claim 5, further comprising the step of adjusting the size of the modified image to match the size of the mug.

18. The non-transient computer readable medium as claimed in claim 1, characterized in that the first aspect ratio and the second aspect ratio are defined according to the following equations:
first aspect ratio: ((D1+D2)/2*π)/Hm
second aspect ratio: L/Hi
wherein
D1: upper diameter;
D2: lower diameter;
Hm: height of modified image;
π: Pi
L: length; and
Hi: height of initial image.

19. The non-transient computer readable medium as claimed in claim 2, characterized in that the first aspect ratio and the second aspect ratio are defined according to the following equations:
first aspect ratio: ((D1+D2)/2*π)/Hm
second aspect ratio: L/Hi
wherein
D1: upper diameter;
D2: lower diameter;
Hm: height of modified image;
π: Pi
L: length; and
Hi: height of initial image.

20. The non-transient computer readable medium as claimed in claim 3, characterized in that the first aspect ratio and the second aspect ratio are defined according to the following equations:
first aspect ratio: ((D1+D2)/2*π)/Hm
second aspect ratio: L/Hi
wherein
D1: upper diameter;
D2: lower diameter;
Hm: height of modified image;
π: Pi
L: length; and
Hi: height of initial image.
